(19) United States
(12) Patent Application Publication
(10) Pub. No.: US 2026/0276890 A1
(43) Pub. Date: Sep. 17, 2026

(54) PHOTONIC INTEGRATED CIRCUIT AND METHOD OF MANUFACTURING A PHOTONIC INTEGRATED CIRCUIT

(71) Applicant: ams-OSRAM International GmbH, Regensburg (DE)

(72) Inventors: Christian Schörner, Regensburg (DE); Anton Buchberger, Graz (AT); Jakob Wilhelm Hinum-Wagner, Graz (AT); Desiree Rist, Graz (AT)

(21) Appl. No.: 19/470,715

(22) PCT Filed: Mar. 26, 2024
(86) PCT No.: PCT/EP2024/058110

§ 371 Date: Sep. 29, 2025

(30) Foreign Application Priority Data
Apr. 6, 2023 (DE) 10 2023 108 967.6

(51) Int. Cl. G02B 6/125; G02B 6/12; G02B 6/132; G02B 6/136

(52) U.S. Cl. CPC G02B 6/125; G02B 6/12002; G02B 6/132; G02B 6/136; G02B 2006/12038; G02B 2006/12097; G02B 2006/12197

(57) ABSTRACT

In an embodiment a photonic integrated circuit includes a substrate with a first surface, a first cladding layer with a second surface and at least one first waveguide provided on the first and second surfaces, wherein the first surface is partially covered by the first cladding layer, wherein the first cladding layer includes a transition area with a sloped surface, wherein the first waveguide is extended from the first surface to the second surface via the sloped surface of the transition area, and wherein a width of the first waveguide on the sloped surface of the transition area is greater than the width of the first waveguide on the first and/or second surfaces.

### CROSS-REFERENCE TO RELATED APPLICATIONS

This patent application is a national phase filing under section 371 of PCT/EP2024/058110, filed Mar. 26, 2024, which claims the priority of German patent application no. 10 2023 108 967.6, filed Apr. 6, 2023, each of which is incorporated herein by reference in its entirety.

### TECHNICAL FIELD

The current invention relates to a photonic integrated circuit and a method of manufacturing a photonic integrated circuit.

### BACKGROUND

Photonic integrated circuits including waveguides for transmission of photonic signals are known form state of the art.

### SUMMARY

Embodiments provide an improved photonic integrated circuit and an improved method for manufacturing a photonic integrated circuit.

According to an embodiment of the invention a photonic integrated circuit is provided, comprising a substrate with a first surface, a cladding layer with a second surface and at least one waveguide provided on the first and second surfaces, wherein the first surface is partially covered by the cladding layer, wherein the cladding layer comprises a transition area with a sloped surface, and wherein the waveguide is extend from the first surface to the second surface of the cladding layer via the sloped surface of the transition area.

Hereby the technical advantage can be achieved, that an improved photonic integrated circuit can be provided. Due to the transition area with the sloped surface the waveguide can be extended over two different height levels with respect to the substrate. A 3 dimensional photonic integrated circuit can be provided comprising stacked waveguides on top of each other whereas one part of each wave-guide level transitions onto the same plane.

According to an embodiment a further waveguide is provided on the first surface and is at least partially covered by the cladding layer.

Hereby the technical advantage can be achieved, that an improved photonic integrated circuit with at least two different waveguides can be provided. Due to the transition area with the sloped surface the two waveguides can be positioned side by side together on one height level and on top of each other with a vertical spacing between each other on two different height levels. This allows for a horizontal connection port, in which the waveguides are positioned side by side on the same height level, and for a vertical connection port, in which the waveguides are positioned vertically spaced to each other on different height levels.

The terms vertical and horizontal refer to a normal direction of the substrate.

The term height level refers to the normal direction of the substrate. Two different height levels can be defined by the first and second surfaces that are vertically spaced to each other with regard to the normal direction.

According to an embodiment the waveguide and the further waveguide are at least partially oriented parallel.

Hereby the technical advantage can be achieved, that the two waveguides can be included in one vertical connection port.

According to an embodiment a slope angle a of the sloped surface of the transition area is smaller than or equal to 30°, preferably smaller than or equal to 20°, most preferably smaller than or equal to 10°.

Hereby the technical advantage can be achieved, that an optimal signal transmission through the waveguide can be achieved. An angle too steep leads to substantial losses in signal quality.

According to an embodiment a length of the sloped surface in a direction of the slope is between 5 μm to 200 μm, preferably between 10 μm to 50 μm.

Hereby the technical advantage can be achieved, that the signal transmission in the waveguide can be further improved. A too short sloped surface leads to a drastic change in height level which leads to a reduction in signal quality.

According to an embodiment the spacing between the waveguide and the further waveguide with regard to the normal direction is between 50 nm to 5 μm, preferably between 100 nm to 1 μm.

Hereby the technical advantage can be achieved, that a signal interference between signals of the two waveguides can be avoided. Further, a space saving solution can be provided, which allows for waveguides on more than two vertically spaced surfaces and height levels.

According to an embodiment the first surface is a surface of a further cladding layer provided on the substrate.

Hereby the technical advantage can be achieved, that with the further cladding layer the waveguides are provided with a solid base. The further cladding layer improves the deposition of the material to form the waveguides. This leads to a better quality of the waveguides and consequential to a better signal transmission. In cases where the substrate has a higher refractive index than the wave-guide material, a cladding layer with lower refractive index could be beneficial.

According to an embodiment a thickness of the further cladding layer is greater or equal to 2 μm.

Hereby the technical advantage can be achieved, that a solid base for the waveguides is provided. This leads to a robust and potent photonic integrated circuit.

According to an embodiment a height step between the sloped surface of the transition area and the first surface is smaller or equal to 100 nm, preferably smaller or equal to 50 nm, most preferably smaller or equal to 10 nm.

Hereby the technical advantage can be achieved, that the change of the waveguide's cross-section at input and output of the sloped area is minimized and thus generates minimal optical losses.

According to an embodiment a width of the waveguide on the sloped surface of the transition area is greater than a width of the waveguide on the fist and/or second surfaces.

Hereby the technical advantage can be achieved, that due to increased width of the waveguide in the sloped surface the signal transmission can be improved and lithographic fabricability within the sloped area can be ensured.

According to an embodiment the width of the waveguide on the first and/or second surfaces is between 50 nm to 10 μm, preferably between 300 nm to 1 μm, and/or wherein the width of the waveguide on the sloped surface of the transition area is greater than 3 μm.

Hereby the technical advantage can be achieved, that an optimal signal transmission of the waveguide can be achieved.

According to an embodiment the photonic integrated circuit comprises multiple waveguides and/or multiple further waveguides, wherein the multiple waveguides and/or the multiple further waveguides are oriented parallel to each other, respectively.

Hereby the technical advantage can be achieved, that due to the multiple waveguides and multiple further waveguides the performance and/or functionality of the photonic integrated circuit can be improved.

According to embodiment of the invention a method of manufacturing a photonic integrated circuit according to any of the preceding embodiments is provided, the method comprising:
providing a substrate with a first surface;
applying a lift off layer on a predefined area of the first surface with, wherein the lift off layer comprises an edge area provided with an undercut portion, and wherein the edge area with the undercut portion is adjacent to an area of the first surface not covered by the lift off layer;
applying a cladding layer with a second surface on the lift off layer and the area of the first surface not covered by the lift off layer and forming a transition area with a sloped surface between the first and second surfaces by applying the cladding layer with gradually decreasing thickness on an area of the first surface underneath the undercut portion of the lift off layer;
removing the lift off layer from the first surface, and
forming a waveguide on the first and second surfaces extending via the sloped surface of the transition layer.

Hereby the technical advantage can be achieved, that an improved method of manufacturing a photonic integrated circuit can be provided. The method included applying a lift off layer with an undercut portion on a predefined area of the first surface. In a following step a cladding layer is applied on the lift off layer and on an area not covered by the lift off area. Deposition material of the cladding layer thereby is deposited in an area underneath the undercut portion. Due to the deposition probability the cladding layer in the area underneath the undercut portion has a gradually decreasing thickness and forms the transition area with the sloped surface. Thus, due to the use of the lift off layer with the undercut portion a technically easy method for generating the transition area with sloped surface can be provided, wherein the transition area provides a smooth transition between the two height levels of the first and second surfaces. This allows for a waveguide that extends between two different height levels.

According to an embodiment the method further comprises:
forming a further waveguide on the first surface prior to the application of the lift off layer and the cladding layer, wherein the applying of the cladding layer on the lift off layer and the first surface comprises:
applying the cladding layer on a part of the further waveguide.

Hereby the technical advantage can be achieved, that a photonic integrated circuit with multiple waveguides on different height levels can be manufactured. Further a waveguide can be connected between the different height levels by means of the sloped area transition.

According to an embodiment the method further comprises:
applying a further cladding layer on the substrate prior to applying the lift off layer and the cladding layer, wherein the first surface is formed by a surface of the further cladding layer.

Hereby the technical advantage can be achieved, that a solid foundation for the waveguides is provided which can be optically transparent.

According to an embodiment the cladding layer and/or the further cladding layer are formed by silicon dioxide depositions, and wherein the deposition comprises a physical vapor deposition PVD, plasma enhanced chemical vapor deposition PECVD, low pressure chemical vapor deposition LPCVD.

Hereby the technical advantage can be achieved, that via the deposition an easy method for applying the cladding layers is provided. Due to the deposition of the material of the cladding layer the sloped transition area can be formed underneath the undercut portion of the lift off layer.

According to an embodiment the method further comprises:
planarizing the cladding layer and/or the further cladding layer prior to applying the waveguide and/or the further waveguide.

Hereby the technical advantage can be achieved, that smooth surfaces can be provided, which benefits the performance of the waveguides. Further, a stacking of multiple waveguide layers is improved by the smooth surfaces.

According to an embodiment the planarizing comprises chemo-mechanical polishing of the cladding layers.

Hereby the technical advantage can be achieved, that a precise planarization is achieved.

According to an embodiment the lift off layer is stabilized by temperature treatment.

Hereby the technical advantage can be achieved, that a stable lift off layer is provided.

According to an embodiment the waveguide and/or the further waveguide are formed by nitride film depositions, and/or wherein the waveguide and/or the further waveguide are formed as rib waveguides.

Hereby the technical advantage can be achieved, that high-quality waveguides can be provided.

### BRIEF DESCRIPTION OF THE DRAWINGS

The above-described properties, features and advantages of this invention, as well as the manner in which they are achieved, become clearer and more clearly understandable in connection with the following description of the embodiments, which are explained in more detail in connection with the drawings.

FIG. 1 shows a schematic view of a photonic integrated circuit according to an embodiment;

FIG. 2 shows a further schematic view of a photonic integrated circuit according to a further embodiment;

FIG. 3 shows a schematic illustration of method steps of a method for manufacturing of a photonic integrated circuit according to an embodiment;

FIG. 4 shows a schematic illustration of further method steps of the method for manufacturing of a photonic integrated circuit;

FIG. 5 shows a further schematic illustration of method steps of the method for manufacturing of a photonic integrated circuit according to a further embodiment; and

FIG. 6 shows a schematic illustration of further method steps of the method for manufacturing of a photonic integrated circuit.

### DETAILED DESCRIPTION OF ILLUSTRATIVE EMBODIMENTS

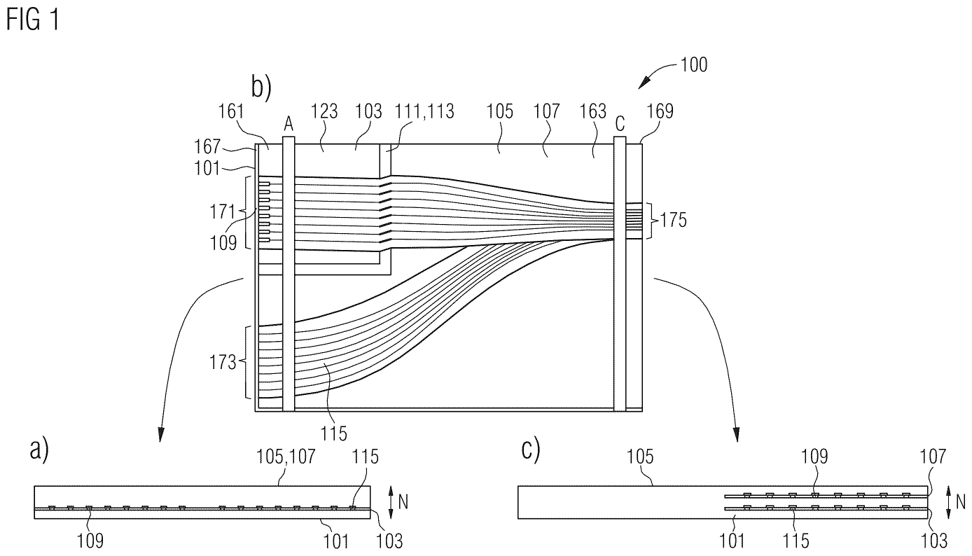

FIG. 1 shows a schematic view of a photonic integrated circuit 100 according to an embodiment.

As shown in the embodiment the photonic integrated circuit 100 comprises a substrate 101 with a set of waveguides 109 and a further set of further waveguides 115. The waveguides 109 and the further waveguides 115 form two sets of mostly parallel waveguides in each set. The number of shown waveguides 109, 115 and the respective routs of each of the waveguides 109, 115 are only exemplary and shall not limit the current invention.

In the current embodiment the further waveguides 115 are entirely positioned on a first surface 103. The first surface 103 defines a first height level with respect to the substrate 101. In the shown embodiment a further cladding layer 123 is applied on the substrate 101. A surface of the further cladding layer 123 defines the first surface 103.

In a first area 161 the multiple waveguides 109 are positioned on the first surface 103 defining the first height level with respect to the substrate 101. On a second area 163 the photonic integrated circuit 101 comprises a cladding layer 105. The cladding layer 105 defines a second surface 107. The second surface 107 defines a second height level with respect to the substrate 101 and comprises a vertical spacing to the first surface 103.

The cladding layer 105 comprises a transition area 111 with a sloped surface 113. The sloped surface 113 provides a transition between the first surface 103 in the first area 161 and the second surface 107 of the cladding layer 105 in the second area 163.

In the shown embodiment the multiple waveguides 109 extend from the first surface 103 via the sloped surface 113 of the transition area 111 to the second surface 107 of the cladding layer 105.

As the multiple further waveguides 115 are positioned on the first surface 103 and therefore on the first height level, comprise a vertical distance to the multiple waveguides 109 in the second area 163, in which the waveguides 109 are positioned on the second surface 107 of the cladding layer 105 and are therefore positioned in the second height level.

Graphics a) and b) illustrate section views of the photonic integrated circuit 100 of graphic b) along the two cutting axis A, C.

In graphic a) it is illustrated that the waveguides 109 and the further waveguides 115 are positioned on the first surface 103 and the respective first height level, respectively. In contrast to this, in graphic c) it is illustrated, that the waveguides 109 and the further waveguides 115 are positioned on different height levels with a vertical distance to each other. The further waveguides 115 are positioned on the first layer 103 and the respective first height level, whereas the waveguides 109 are positioned on the second surface 107 of the cladding layer 105 and therefore on the respective second height level.

On a first edge 167 of the photonic integrated circuit 100the multiple waveguides 109 are comprised in a first terminal area 171. The further waveguides 115 are comprised in a second terminal area 173. The first and second terminal areas 171, 173 are both located on the first surface 103 and the respective first height level. On a second edge 169 of the photonic integrated circuit 100 the multiple waveguides 109 and the multiple waveguides 115 are combined into a third terminal area 175. In the third terminal area 175 the respective waveguides 109 are spaced vertically with respect to the further waveguides 115.

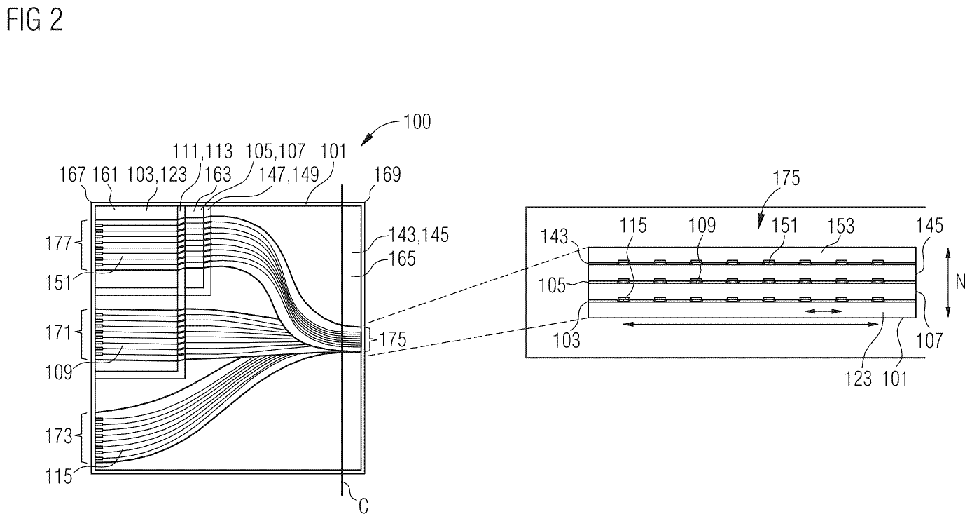

FIG. 2 shows a further schematic view of a photonic integrated circuit 100 according to a further embodiment.

The shown embodiment is based on the embodiment in FIG. 1 and comprises all features shown there. In the embodiment of FIG. 2 the photonic integrated circuit 100 comprises an additional cladding layer 145 positioned on top of the cladding layer 105. The additional cladding layer 145 defines a third surface 143 which is vertically spaced to the second surface 107 of the cladding layer 105 and therefore defines a third height level. The additional cladding layer 145 is positioned in a third area 165 and comprises a further transition area 147 with a further sloped surface 149. The further transition area 147 and in particular the further sloped surface 149 provides a transition between the third surface 143 of the additional cladding layer 145 and the second surface 107 of the cladding layer 105 or between the third surface 143 of the additional cladding layer 145 and the first surface 103 of the further cladding layer 123 in the first area 161.

In the shown embodiment the photonic integrated circuit 100 comprises a further set of multiple additional waveguides 151. In the first area 161 the additional waveguides 151 are positioned on the first surface 103 of the further cladding 123. In the second area 163 the additional waveguides 151 are positioned on the second surface 107 of the cladding layer 105. In the third area 165 the additional waveguides 151 are positioned on the third surface 143 of the additional cladding layer 145. The additional waveguides 151 therefore extend from the first surface 103 via the sloped surface 113 of the transition area 111 onto the second surface 107 of the cladding layer 105 and via the further sloped surface 149 of the further transition area 147 onto the third surface 143 of the additional cladding layer 145.

On the first edge 167 the additional waveguides 151 are combined into a fourth terminal area 177. The first terminal area 171, the second terminal area 173 and the fourth terminal area 177 are positioned on the first surface 103. On the second edge 169 the waveguides 109, the further waveguides 115 and the additional waveguides 151 are all combined into the third terminal area 175. In the third terminal area 175 all waveguides 109, 115, 151 are positioned on three different surfaces 103, 107, 143 and three different height levels respectively.

In graphic b) a section view of the photonic integrated circuit 100 along the cutting axis C is illustrated. It is shown that in the third terminal area 175 the three sets of waveguides 109, 115, 151 are spaced vertically with respect to a normal direction 121 of the substrate 101. In the embodiment of graphic b) the additional waveguides 151 are further covered by a fourth cladding layer 153. Each of the sets of waveguides 109, 115, 151 can be spaced to each other by for example approximately 3 μm in-plane. The entire set of waveguides can be spaced for example by about 21 μm. A different spacing of the waveguides 109, 115, 151 is also possible.

The number of different sets of waveguides 109, 115, 151 as well as the number of waveguides in each set is just exemplary and shall not limit the scope of the invention.

In the terminal areas 171, 173, 175, 177 the waveguides 109, 115, 151 of each set are oriented mostly parallel to waveguides of the respective sets. This allows for an easy and efficient connection of the photonic integrated circuit 100 with other components.

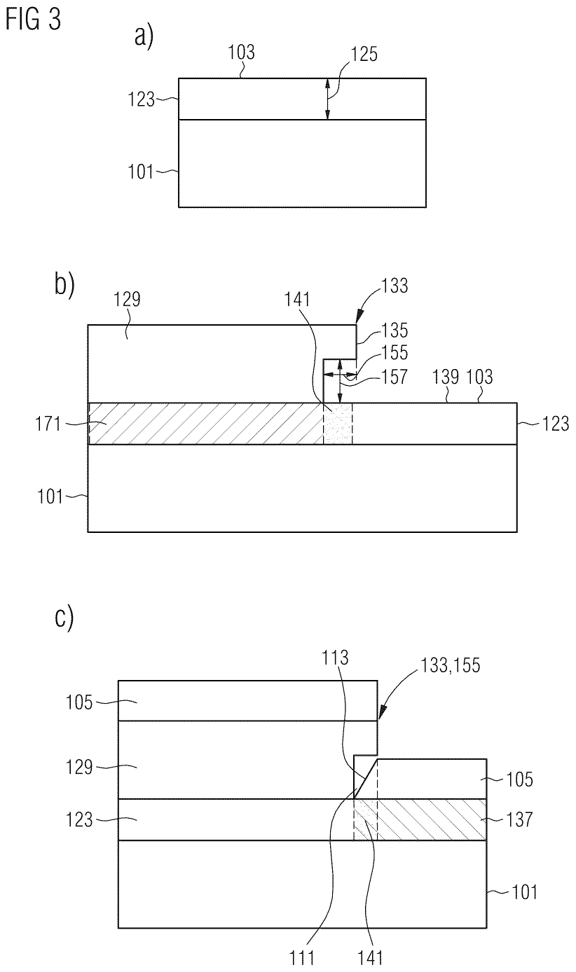

FIG. 3 shows a schematic illustration of method steps of a method for manufacturing of a photonic integrated circuit 100 according to an embodiment.

In graphics a), b), c) three steps of the inventive method for manufacturing a photonic integrated circuit 100 according to the embodiments in FIGS. 1 and 2 are shown.

In graphic a) a substrate 101 with a fist surface 103 is provided. In the shown embodiment the first surface 103 is defined by a surface of a further cladding layer 123 applied on the substrate 101.

According to an embodiment the further cladding layer is formed by a silicon dioxide deposition. The deposition can comprise a physical vapor deposition PVD, a plasma-enhanced chemical vapor deposition PEDVD or a low pressure chemical vapor deposition LPCVD.

If the further cladding layer 123 is directly applied onto the substrate 101 the further cladding layer 123 can be grown as wet thermal silicon dioxide. Thermal oxide has the advantage of a very smooth surface and a very homogenous thickness distribution.

According to a further embodiment a thickness 125 of the further cladding layer 123 is greater or equal to 2 μm. This minimizes the losses to leakage due to interactions of the evanescent field of the propagating mode in the waveguide with the bare silicon of the substrate 101.

According to graphic b) in a further method step a lift off layer 129 is applied on the first surface 103 in a predefined area 131. The predefined area 131 is just a fraction of the entire area of the first surface 103, such that a substantial area 139 of the first surface 103 is not covered by the lift off layer 129. The lift off layer 129 comprises an edge area 133 adjacent to the area 139 of the first surface 103 not covered by the lift off layer 129. In the edge area 133 the lift off layer 129 comprises an undercut portion 135 with a length 155 and a height 157 and defines an area 141 of the first surface 103 positioned underneath the undercut portion 135.

The undercut portion 135 of the lift off layer 129 can be generated according to the method disclosed in U.S. Patent Application 2016/0179009, which is incorporate herein by reference in its entirety.

The lift off layer 129 can be made of a spin coated negative lift-off resin.

According to an embodiment the lift off layer 129 is stabilized by a temperature treatment prior to the deposition of the cladding layer 105.

In another method step, illustrated in graphic c), a cladding layer 105 is applied on the lift off layer 129 as well as the area 139 of the first surface 103 not covered by the lift off layer 129.

According to an embodiment the cladding layer 105 is formed by a silicon dioxide deposition, preferably a physical vaper deposition PVD or any low temperature deposition technique.

Due to the deposition process of the silicon dioxide material of the cladding layer 105 silicon dioxide material is deposited on the area 141 of the first surface 103 positioned underneath the undercut portion 135. Due to the deposition probability of silicon dioxide material of the cladding layer 105 in the area 141 underneath the undercut portion 135 the cladding layer 105 comprises a transition area 111 positioned in the area 141 underneath the undercut portion 135. The transition area 111 comprises a gradually decreasing thickness and therefore has a sloped surface 113.

A slope angle a of the transition area 111 well as a length of the sloped surface 113 can be varied by a variation of the length 155 and height 157 of the undercut portion 135.

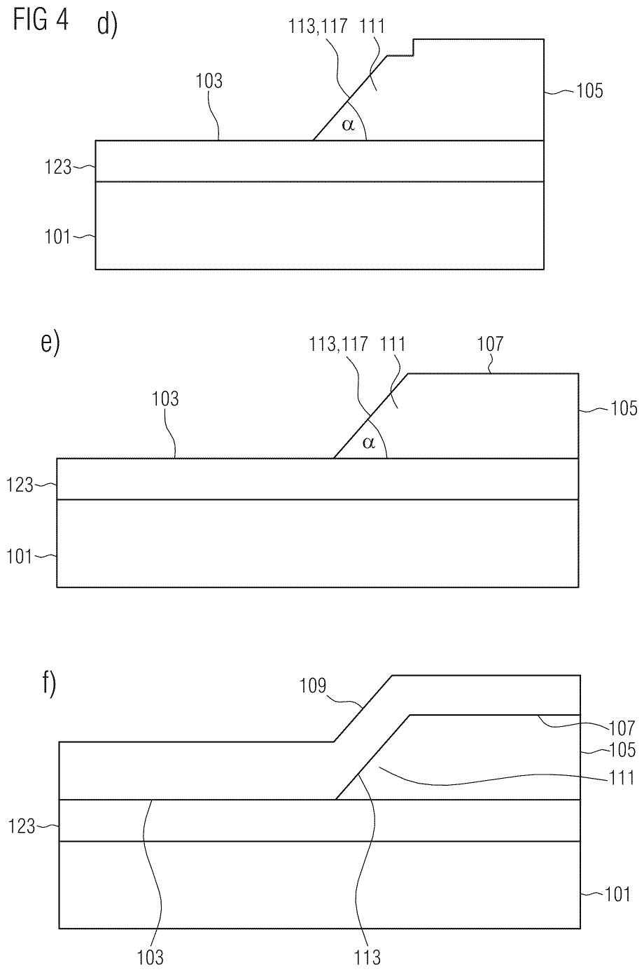

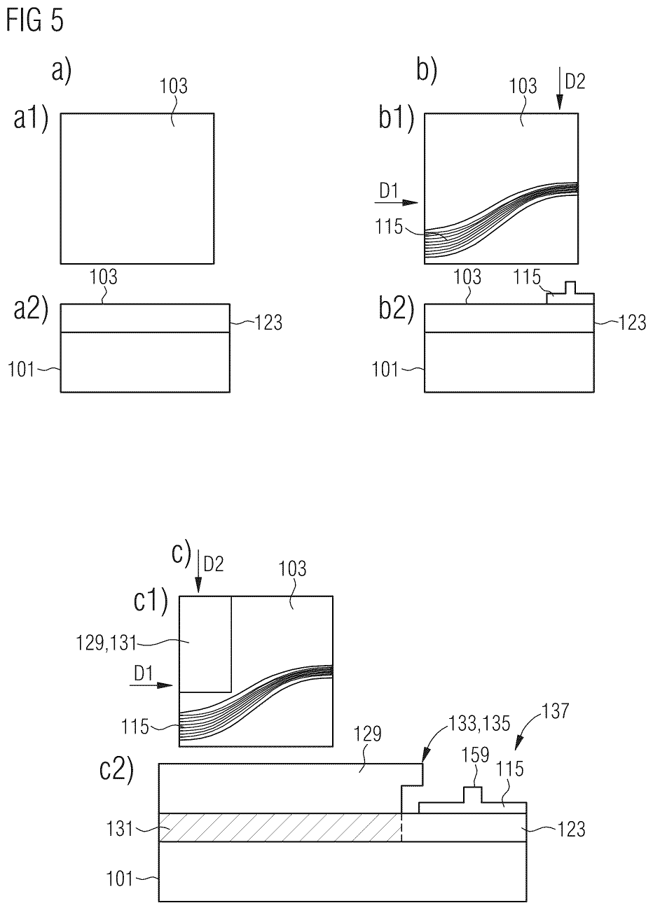

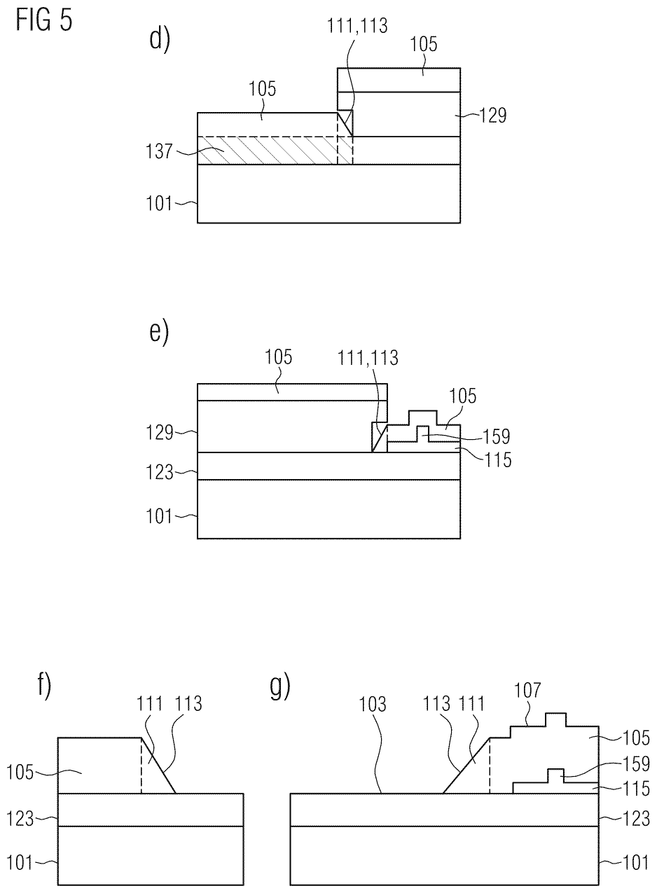

FIG. 4 shows a schematic illustration of further method steps of the method for manufacturing of a photonic integrated circuit 100.

The graphics d), e), f) illustrate three further method steps of the inventive method of manufacturing a photonic integrated circuit. The method steps in graphics d), e), f) are a continuation of the method steps in graphics a), b), c) in FIG. 3.

In the method step shown in graphic d) the lift off layer 129 is removed from the first surface 103 of the further cladding layer 123. The removal of the lift off layer 129 is achieved by washing the lift off layer 129 off the further cladding layer 123 using multiple liquids in a two-step method. The cladding layer 105 is removed with the lift off layer 129. The removal can be achieved by means of washing off the respective layers.

In graphic d) it is further illustrated, that the sloped surface 113 of the transition area 111 comprises a slope-angle a with respect to the first surface 103 of the further cladding layer 123. According to an embodiment the slope-angle a of the sloped surface 113 is smaller than or equal to 30°. Preferably the slope-angle a is smaller than or equal to 20°. Most preferably, the slope-angle α is smaller than or equal to 10°.

In the next method step illustrated in graphic e) a planarization of the cladding layer 105 and/or the further cladding layer 123 is performed. The planarization can comprise a chemo-mechanical polishing of the cladding layers 105, 123. Through the planarization the first surface 103 and the second surface 107 are defined or at least are formed into even surfaces, that can be oriented parallel to the surface of the substrate 101. The sloped surface 113 of the transition area 111 of the cladding layer 107 can further be included into the planarization process. Due to the smooth surfaces of the cladding layers waveguide losses can be limited. The planarization has to be optimal, to on the one hand minimize the defect number and size and on the other hand prevent from dielectric erosion which may occur at too long planarization times.

According to a further embodiment a length 117 of the sloped surface 113 of the transition area 111 is between 5 μm to 200 μm, preferable between 10 μm to 15 μm. The length 117 is oriented in a direction of the slope of the sloped surface 113.

In a further method step, illustrated in graphic f) a waveguide 109 is formed on the first and second surfaces 103, 107 extending via the sloped surface 113 of the transition layer 111. According to an embodiment the waveguide 109 is formed by a nitride film deposition. According to a further embodiment the waveguide 109 can be formed as a rib waveguide.

The deposition of the nitride film used for the generation of the waveguide 109 can be applied via PECVD or LPCVD. The structuring of the rib 159 can be achieved in a two-step process. First the rib is structured to a defined height of for example approx. 350 nm via a reactive ion etch process for in constant-time etch step. Afterwards the first multiridge structure is etched by a consecutive reactive ion etch step with an etch stop on the cladding layer 105.

According to a further embodiment a rib 159 of the waveguide 109 on sloped surface 113 of the transition area 111 is greater than a rib 159 of the waveguide 109 on the first and/or second surfaces 103, 107. According to a further embodiment the height of the rib 159 of the waveguide 109 on the first and/or second surfaces 103, 107 is between 50 nm to 10 μm, preferably between 300 nm to 1 μm. The width of the waveguide 109 on the sloped surface 113 of the transition area 111 can be greater than 3 μm.

FIG. 5 shows a further schematic illustration of method steps of the method for manufacturing of a photonic integrated circuit 100 according to a further embodiment.

The embodiment of the method of manufacturing a photonic integrated circuit 100 shown in FIG. 5 is based on the embodiment of the method shown in FIGS. 3 and 4 and comprises all method steps shown in said Figures.

Similar to the embodiment in FIGS. 3 and 4 in the first method step, as illustrated in graphic a), the substrate 101 with the further cladding layer 123 defining the first surface 103 is provided according to the embodiment of FIG. 3.

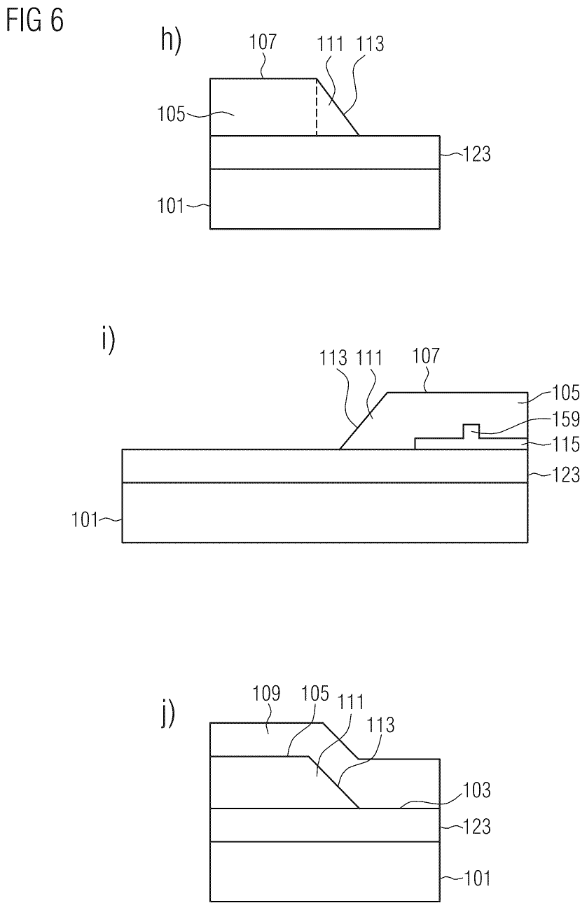

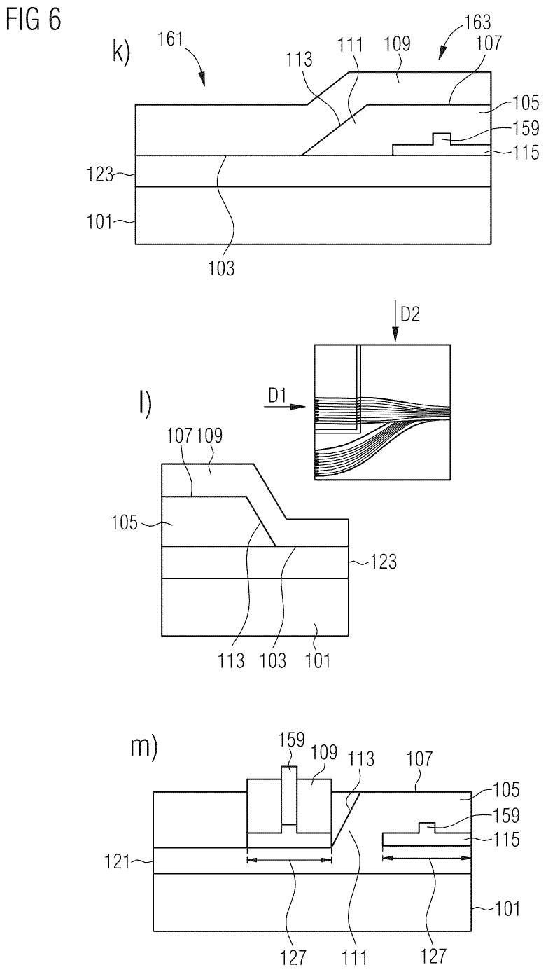

In the embodiment shown in FIGS. 5 and 6, contrary to the embodiment shown in FIGS. 3 and 4, a further waveguide 115 is provided on the first surface 103 of the further cladding layer 123. This is done in the method step shown graphic b). Graphic b1) shows an aerial view of the substrate 101 with the further cladding layer 123 and the set of further waveguides 115 applied on the first surface 103. The graphic b2) shows a section view of the substrate 101 of graphic b1) along a first direction D1.

The further waveguide 115 is generated analogously to the waveguide 109 via the nitride film deposition.

In the method step of graphic c) the lift off layer 129 is applied in the predefined area 131. The lift off layer 129 does not cover the further waveguide 115 provided on the first surface 103. Even a spacing between lift off layer 129 and further waveguide 115 is possible. The lift off layer 129 again comprises the undercut portion 135 in the edge area 133 adjacent to the area 137 not covered by the lift off layer 129. Graphic c2) again shows a section view of the photonic integrated circuit 100 along the first direction D1.

In the method step of graphic d) the cladding layer 105 is applied on the lift off layer 129 and the area 137 not covered by the lift off layer 129. Graphic d) shows a section view of the photonic integrated circuit 100 along the second direction D2.

Graphic e) shows the deposition step of the cladding layer 105 shown in graphic d) along the first direction D1.

In a following method step shown in graphics f) and g) the lift off layer 129 plus the cladding layer 105 applied on the lift off layer 129 is removed from the predefined area 131 of the first surface 103. As is illustrated in graphic g) the further waveguide 115 provided on the first surface 103 of the further cladding layer 123 is covered by the cladding layer 105. Similar to the embodiment shown in FIGS. 3 and 4 the cladding layer 105 comprises the transition area 111 with the sloped surface 113. The sloped surface 113 provides a transition between the first surface 103 of the further cladding layer 123 and the second surface 107 of the cladding layer 105. In graphic g) the second surface 107 of the cladding layer 105 is shown as a rough surface prior to the planarization process. The rough surface comprises kinks and steps originating from the waveguide topography below.

FIG. 6 shows a schematic illustration of further method steps of the method for manufacturing of a photonic integrated circuit 100.

The method steps illustrated in graphics h) to m) are a continuation of the method steps shown in graphics a) to g) in FIG. 5.

The planarizing of the first surface 103 and/or the second surface 107 and/or the sloped surface 113 of the transition area 111 is illustrated in the graphics H and I. The graphics h) and i) similar to the graphics f) and g) show section views of the photonic integrated circuit 100 along the second and first directions, respectively. In the method steps of graphics H and I the planarization of the surfaces 103, 107, 113 can be achieved via a chemo-mechanical polishing.

In a further method step, illustrated in graphic j), the waveguide 109 is formed on the first surface 103 and the second surface 107 and extends via the sloped surface 113 of the transition area 111. As shown in graphic k) the waveguide 109, positioned on the second surface 107 of the cladding layer 105 is positioned above the further waveguide 115 positioned on the first layer 103 of the further cladding layer 123. In the first area 161 both waveguides 109, 115 are positioned on the first surface 103 of the further cladding layer 123 and are positioned on a similar height level with respect to the substrate 101. In the second area 163 the waveguide 109 is positioned on the second surface 107 of the cladding layer 105 and therefore on a second height level, whereas the further waveguide 115 is positioned on the first surface 103 and therefore the first height level with respect to the substrate 101. The two waveguides 109, 115 are spaced vertically with respect to the substrate 101.

In graphics l) and m) it is illustrated, that the waveguides 109, 115 can be formed as rib waveguides. According to an embodiment the waveguide 109 can be formed by a nitride film deposition.

In graphic m) the width 127 of the waveguide 109 and the further waveguide 115 is identical. As already mentioned above, the width 127 of the waveguide 109 can be greater on the sloped surface 113 than on the first or second surfaces 103, 107. Alternatively, the widths of the waveguides 109, 115 can different.

The invention was illustrated and described in more detail by means of the preferred embodiments. Nevertheless, the invention is not limited to the disclosed examples. Other variations can be derived by those skilled in the art.

1-20. (canceled)

21. A photonic integrated circuit comprising:
a substrate with a first surface, a first cladding layer with a second surface and at least one first waveguide provided on the first and second surfaces,
wherein the first surface is partially covered by the first cladding layer,
wherein the first cladding layer comprises a transition area with a sloped surface,
wherein the first waveguide is extended from the first surface to the second surface via the sloped surface of the transition area, and
wherein a width of the first waveguide on the sloped surface of the transition area is greater than the width of the first waveguide on the first and/or second surfaces.

22. The photonic integrated circuit of claim 21, further comprising a second on the first surface and at least partially covered by the first cladding layer.

23. The photonic integrated circuit of claim 21, wherein the first waveguide and a second waveguide are at least partially oriented parallel.

24. The photonic integrated circuit of claim 21, wherein a slope angle of the sloped surface of the transition area is smaller than or equal to 30°.

25. The photonic integrated circuit of claim 21, wherein a length of the sloped surface in a direction of the slope is between 5 μm and 200 μm, inclusive.

26. The photonic integrated circuit of claim 21, wherein a spacing between the first waveguide and a second waveguide with regard to a normal direction of the substrate is between 50 nm and 5 μm, inclusive.

27. The photonic integrated circuit of claim 21, wherein the first surface is a surface of a second cladding layer provided on the substrate.

28. The photonic integrated circuit of claim 27, wherein a thickness of the second cladding layer is greater or equal to 2 μm.

29. The photonic integrated circuit of claim 21, wherein a height step between the sloped surface of the transition area and the first surface is smaller or equal to 100 nm.

30. The photonic integrated circuit of claim 21, wherein the width of the first waveguide on the first and/or second surfaces is between 50 nm and 10 μm, inclusive, and/or wherein the width of the first waveguide on the sloped surface of the transition area is 0.5 μm, 1 μm or greater than 3 μm.

31. The photonic integrated circuit of claim 21, wherein the photonic integrated circuit comprises first multiple waveguides and/or second multiple waveguides, and wherein the first multiple waveguides and/or the second multiple waveguides are oriented parallel to each other, respectively.

32. A method for manufacturing the photonic integrated circuit according to claim 21, the method comprising:
providing the substrate;
applying a lift off layer on a predefined area of the first surface, wherein the lift off layer comprises an edge area comprising an undercut portion, and wherein the edge area with the undercut portion is adjacent to an area of the first surface not covered by the lift off layer;
applying the first cladding layer with the second surface on the lift off layer and the area of the first surface not covered by the lift off layer and forming the transition area with the sloped surface between the first and second surfaces by applying the first cladding layer with a gradually decreasing thickness on the area of the first surface underneath the undercut portion of the lift off layer;
removing the lift off layer from the first and second surfaces; and
forming the first waveguide on the first and second surfaces extending via the sloped surface of the transition area.

33. The method of claim 32, further comprising forming a second waveguide on the first surface prior to applying the lift off layer and the first cladding layer, wherein the applying of the first cladding layer on the lift off layer and the first surface comprises applying the first cladding layer at least on a part of the second waveguide.

34. The method of claim 32, further comprising applying a second cladding layer on the substrate prior to applying the lift off layer and the first cladding layer, wherein the first surface is formed by a surface of the second cladding layer.

35. The method of claim 32, wherein the first cladding layer and/or a second cladding layer are formed by silicon dioxide depositions, and wherein the deposition comprises a physical vapor deposition (PVD), a plasma enhanced chemical vapor deposition (PECVD), or a low pressure chemical vapor deposition (LPCVD).

36. The method of claim 32, further comprising planarizing the first cladding layer and/or a second cladding layer prior to applying the first waveguide and/or a second waveguide.

37. The method of claim 36, wherein planarizing comprises chemo-mechanical polishing of the cladding layers.

38. The method of claim 32, wherein the lift off layer is stabilized by a temperature treatment.

39. The method of claim 32, wherein the first waveguide and/or a second waveguide are formed by nitride film depositions, and/or wherein the first waveguide and/or the second waveguide are formed as rib waveguides.
